(19) United States
(12) Patent Application Publication
(10) Pub. No.: US 2016/0157041 A1
(43) Pub. Date: Jun. 2, 2016

(54) VEHICLE ACOUSTIC CONTROL DEVICE, AND VEHICLE ACOUSTIC CONTROL METHOD

(71) Applicant: NISSAN MOTOR CO., LTD., Kanagawa (JP)

(72) Inventors: Yuuki SHIOZAWA, Sagamihara-shi, Kanagawa (JP); Tatsuya SUZUKI, Yokohama-shi, Kanagawa (JP); Kazuma OURA, Atsugi-shi, Kanagawa (JP)

(21) Appl. No.: 14/785,806

(22) PCT Filed: Apr. 23, 2014
(86) PCT No.: PCT/JP2014/002289

§ 371 Date: Oct. 20, 2015

(30) Foreign Application Priority Data
Apr. 24, 2013 (JP) 2013-091680
Apr. 24, 2013 (JP) 2013-091681

(51) Int. Cl. H04S 7/00

(52) U.S. Cl. CPC H04S 7/303; H04S 7/305; H04R 2499/13

(57) ABSTRACT

A plurality of speakers disposed so as to surround a periphery of a passenger when viewed from above and a controller configured to control a sound field in a vehicle cabin by individually driving the plurality of speakers. The controller is configured, when an operation input for changing a vehicle behavior is made, to set a normative yaw rate depending on the operation input, to detect an actual yaw rate of the vehicle, and to rotate the sound field in the vehicle cabin in the direction of a change in the actual vehicle behavior depending on the deviation of the actual yaw rate relative to the normative yaw rate. That is, a change of a turning behavior depending on the operation input is rendered before the change of the actual turning behavior.

### CROSS REFERENCE TO RELATED APPLICATIONS

The entire contents of Japanese Patent Application No. 2013-091680 (filed on Apr. 24, 2013) and Japanese Patent Application No. 2013-091681 (filed on Apr. 24, 2013) in which the priority right of the present patent application is claimed are herein incorporated by reference.

### TECHNICAL FIELD

The present invention relates to a vehicle acoustic control device and a vehicle acoustic control method.

### BACKGROUND

JP 4305333 focuses on the fact that a head portion of a driver moves following a change of a vehicle behavior, and proposes to keep a desired acoustic effect by estimating a motion of the head portion of the driver from map information and a travel state of a vehicle, and by controlling a sound field in a vehicle cabin to follow the motion.

The above-described technology of JP 4305333 attempts matching between such a motion of the driver and a motion of the sound field in the vehicle cabin. In general, however, the driver imagines a vehicle behavior after his/her driving operation based on the driving operation. Thus, mismatch between the imagined vehicle behavior and the motion of the sound field may result in deterioration of a feeling of operation.

### SUMMARY

It is an object of the present invention to improve the matching between the imagined vehicle behavior and the motion of the sound field in the vehicle cabin.

According to an embodiment of the present embodiment, there is provided a vehicle acoustic control device including a plurality of speakers each disposed on a periphery of a passenger and controlling a sound field in a vehicle cabin by individually driving the plurality of speakers. Then, a steering operation is detected, a turning behavior is estimated based on the steering operation, an actual turning behavior of a vehicle which is turning is detected, and when the steering operation is detected, the sound field in the vehicle cabin is changed in a direction of a change in the actual turning behavior depending on an deviation between the estimated turning behavior and the actual turning behavior.

According to an embodiment of the present disclosure, by changing the sound field in the vehicle cabin in the direction of the change in the actual turning behavior depending on the deviation between the estimated turning behavior and the actual turning behavior, a change of a vehicle behavior depending on the steering operation can be rendered before a change of an actual vehicle behavior. Therefore, the matching between the imagined vehicle behavior and the motion of the sound field in the vehicle cabin can be improved.

### BRIEF DESCRIPTION OF THE DRAWINGS

FIG. 1 is a configuration diagram of a vehicle acoustic control device;

FIG. 1 is a configuration diagram of a vehicle acoustic control device;

FIG. 2 is a block diagram illustrating an example of acoustic control processing in a first embodiment;

FIG. 3 is an example of a map for use in setting a sound field rotation amount α;

FIG. 4 is an example of the map for use in setting the sound field rotation amount α (dead band, limit);

FIG. 5 is an example of the map for use in setting the sound field rotation amount α (hysteresis);

FIG. 6 is a view schematically illustrating a vehicle cabin space when viewed from above;

FIG. 7 is a flowchart illustrating an example of the acoustic control processing in the first embodiment;

FIG. 8 is a time chart explaining a response difference in an actual vehicle behavior;

FIG. 9 is a time chart explaining recognition timing of a behavior change;

FIGS. 10A and 10B are views explaining virtual walls;

FIG. 11 is a block diagram illustrating an example of acoustic control processing in a second embodiment;

FIG. 12 is an example of the map for use in setting the sound field rotation amount α;

FIG. 13 is an example of the map for use in setting the sound field rotation amount α (dead band, limit);

FIG. 14 is an example of the map for use in setting the sound field rotation amount α (hysteresis); and

FIG. 15 is a flowchart illustrating an example of the acoustic control processing in the second embodiment.

### DETAILED DESCRIPTION OF THE EMBODIMENTS

A description is made below of embodiments of the present invention based on the drawings.

### First Embodiment

### (Configuration)

First, a description is made of a configuration of a vehicle acoustic control device.

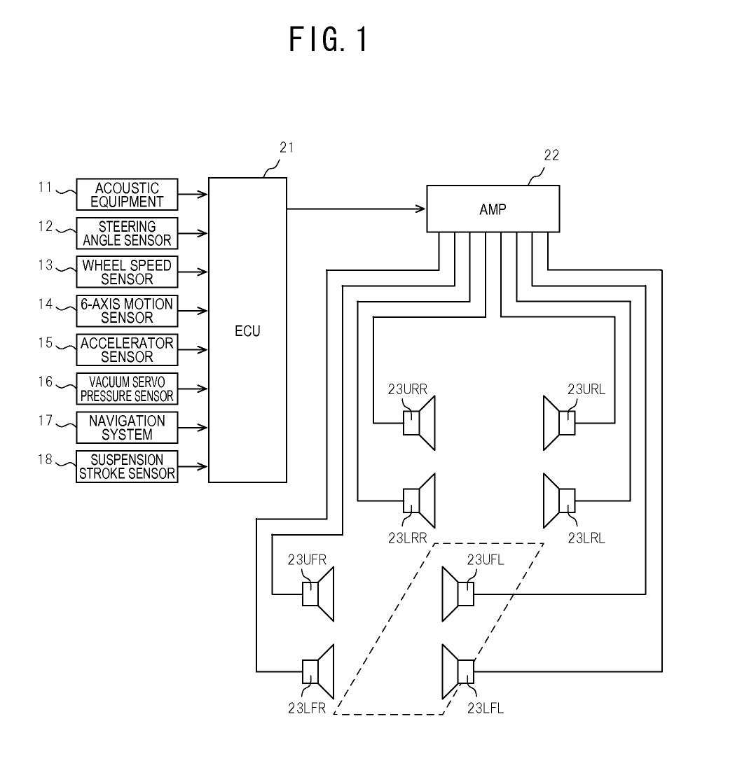

FIG. 1 is a configuration diagram of the vehicle acoustic control device.

The vehicle acoustic control device is mounted on an automobile, and includes: acoustic equipment 11; a steering angle sensor 12; a wheel speed sensor 13; a 6-axis motion sensor 14; an accelerator sensor 15; a vacuum servo pressure sensor 16; a navigation system 17; a suspension stroke sensor 18; and a controller 21.

The acoustic equipment 11 outputs sound signals that enable so-called stereophonic reproduction of reproducing a multiple-channel sound. This acoustic equipment 11 is composed, for example, of a CD drive, a DVD drive, a hard disk drive, a flash memory drive, an AM/FM/TV tuner, a portable audio player or the like. That is to say, by the CD drive, the DVD drive, the hard disk drive, the flash memory drive or the like, sound information is read out from a variety of recording media, and so on, and the sound information is received by a wireless communication made through such an AM/FM/TV tuner or the like, the sound information is inputted from the portable audio player connected through a USB interface or a wireless communication module or the like, and so on. The acoustic equipment 11 outputs the acquired sound signals to the controller 21.

The steering angle sensor 12 is composed of a rotary encoder, and detects a steering angle θs of a steering shaft. When a disc-like scale rotates together with the steering shaft, this steering angle sensor 12 detects light, which transmits through a slit of the scale, with two phototransistors, and outputs a pulse signal, which follows rotation of the steering shaft, to the controller 21. The controller 21 determines the steering angle θs of the steering shaft from the pulse signal inputted thereto. Note that the controller 21 treats clockwise turning as a positive value, and treats counterclockwise turning as a negative value.

The wheel speed sensor 13 detects wheel speeds VwFL to VwRR of the respective wheels. For example, this wheel speed sensor 13 detects magnetic field lines of a sensor rotor by using a detection circuit, converts a change of a magnetic field, which follows rotation of the sensor rotor, into a current signal, and outputs the current signal to the controller 21. The controller 21 determines the wheel speeds VwFL to VwRR from the current signal inputted thereto.

In three axes (X-axis, Y-axis, Z-axis) perpendicular to one another, the 6-axis motion sensor 14 detects accelerations (Gx, Gy, Gz) in directions of the respective axes and angular velocities (ωx, ωy, ωz) about the respective axes. Here, a longitudinal direction of a vehicle body is defined as the X-axis, a crosswise direction of the vehicle body is defined as the Y-axis, and a vertical direction of the vehicle body is defined as the Z-axis. In a case of the acceleration, for example, this 6-axis motion sensor 14 detects positional displacements of movable electrodes with respect to fixed electrodes as changes of electrostatic capacitances, converts the changes of the electrostatic capacitances into voltage signals proportional to accelerations in the respective axis directions and to orientations of the accelerations, and outputs the voltage signals to the controller 21. The controller 21 determines the accelerations (Gx, Gy, Gz) from the voltage signals inputted thereto.

Note that the 6-axis motion sensor 14 detects, as positive values, the acceleration in the longitudinal direction, the clockwise turning in the crosswise direction, and a bound in the vertical direction, and detects, as negative values, a deceleration in the longitudinal direction, the counterclockwise turning in the crosswise direction, and a rebound in the vertical direction. Moreover, in a case of the angular velocity, the 6-axis motion sensor 14 vibrates vibrators composed, for example, of crystal tuning forks by an alternating current voltage, converts amounts of distortion of the vibrators, which are generated by the Coriolis force when the angular velocity is inputted, into electrical signals, and outputs the electrical signals to the controller 21. The controller 21 determines such angular velocities (ωx, ωy, ωz) from the electrical signals inputted thereto. Note that the 6-axis motion sensor 14 detects, as positive values, the clockwise turning about a longitudinal axis (roll axis), the acceleration about a crosswise axis (pitch axis), and the clockwise turning about a vertical axis (yaw axis), and detects, as negative values, the counterclockwise turning about the longitudinal axis (roll axis), the deceleration about the crosswise axis (pitch axis), and the counterclockwise turning about the vertical axis (yaw axis).

The accelerator sensor 15 detects a pedal opening degree PPO (operation position) corresponding to a stepping amount of an accelerator pedal. For example, this accelerator sensor 15 is a potentiometer, converts the pedal opening degree PPO of the accelerator pedal into a voltage signal, and outputs the voltage signal to the controller 21. The controller 21 determines the pedal opening degree PPO of the accelerator pedal from the voltage signal inputted thereto. Note that the pedal opening degree PPO becomes 0% when the accelerator pedal is at a non-operation position, and that the pedal opening degree PPO becomes 100% when the accelerator pedal is at a maximum operation position (stroke end).

The vacuum servo pressure sensor 16 detects a pressure in a vacuum servo (brake booster), that is, brake pedal stepping force Pb. This vacuum servo pressure sensor 16 receives the pressure in the vacuum servo by a diaphragm portion, detects distortion, which is generated in a piezoresistance element through this diaphragm portion, as a change of electrical resistance, converts the change of the electrical resistance into a voltage signal proportional to the pressure, and outputs the voltage signal to the controller 21. The controller 21 determines the pressure in the vacuum servo, that is, the brake pedal stepping force Pb from the voltage signal inputted thereto.

The navigation system 17 recognizes a current position of a vehicle on which the vehicle acoustic control device is mounted and road map information at the current position. This navigation system 17 has a GPS receiver, and recognizes the position (latitude, longitude, altitude) and the travel direction of the vehicle based on time differences between radio waves arriving from four or more GPS satellites. Then, the navigation system 17 refers to road map information including a road type, a road alignment, a lane width, a vehicle passing direction and the like, which are stored in the DVD-ROM drive and the hard disk drive, recognizes the road map information at the current position of the vehicle, and outputs the road map information to the controller 21. Note that the navigation system 17 may receive a variety of data from an infrastructure by using DSRC (Dedicated Short Range Communication) as DSSS (Driving Safety Support Systems).

The suspension stroke sensor 18 detects suspension strokes in the respective wheels. For example, this suspension stroke sensor 18 is composed of a potentiometer, converts rotation angles of suspension links into voltage signals, and outputs the voltage signals to the controller 21. Specifically, the suspension stroke sensor 18 outputs a standard voltage at a non-stroke time in which the vehicle is in a stationary state, outputs voltages smaller than the standard voltage at a bound-stroke time, and outputs the voltage larger than the standard voltage at a rebound-stroke time. The controller 21 determines the suspension strokes in the respective wheels from the voltage signals inputted thereto.

The controller (ECU) 21 is composed, for example, of a microcomputer, executes acoustic control processing based on detection signals from the respective sensors, and drives speakers 23LFL to 23LRR and 23UFL to 23URR through an amplifier (AMP) 22. Note that, in a case where it is not necessary to distinguish the respective speakers, the speakers are described while being denoted by “23” as reference numeral.

The amplifier 22 amplifies the sound signals inputted thereto through the controller 21, then outputs the sound signals to the speakers 23, and moreover, individually adjusts volumes of a treble range, a midrange and a bass range, and adjusts a volume of the stereophonic reproduction for each of channels.

Each of the speakers 23 converts the electrical signal, which is inputted thereto through the amplifier 22, into a physical signal, and outputs the sound. The respective speakers 23 are provided in a vehicle cabin, and for example, are composed of dynamic speakers. That is to say, the electrical signal is inputted to a coil connected directly to a diaphragm, and each of the speakers 23 vibrates the diaphragm by vibration of the coil, which is caused by electromagnetic induction, whereby radiating a sound corresponding to the electrical signal. Each of the speakers 23 may be formed as not only a full-range speaker for the entire bandwidth but also a multi-range speaker composed of a multi-way speaker such as a woofer for the bass range, a squawker for the midrange, and a tweeter for the treble range.

Three English letters assigned to the reference numeral of each of the speakers 23 indicate an attachment position thereof in the vehicle cabin: a first letter indicates a vertical position in the vehicle cabin; a second English letter indicates a longitudinal position in the vehicle cabin; and a third English letter indicates a crosswise position in the vehicle cabin. That is to say, “L” as the first English letter indicates a lower side in the vehicle cabin, and “U” as the first English letter indicates an upper side in the vehicle cabin. Moreover, “F” as the second English letter indicates a front side in the vehicle cabin, and “R” as the second English letter indicates a rear side in the vehicle cabin. Furthermore, “L” as the third English letter indicates a left side in the vehicle cabin, and “R” as the third English letter indicates a right side in the vehicle cabin.

Hence, among the respective speakers 23, “LFL” is located on the lower side/front side/left side in the vehicle cabin, “LFR” is located on the lower side/front side/right side in the vehicle cabin, “LRL” is located on the lower side/rear side/left side in the vehicle cabin, and “LRR” is located on the lower side/rear side/right side in the vehicle cabin. Moreover, “UFL” is located on the upper side/front side/left side in the vehicle cabin, “UFR” is located on the upper side/front side/right side in the vehicle cabin, “URL” is located on the upper side/rear side/left side in the vehicle cabin, and “URR” is located on the upper side/rear side/right side in the vehicle cabin. Note that, preferably, the lower side/upper side, the front side/rear side and the left side/right side individually take, as a reference, a listening point of a driver, and specifically, a head portion (ear points) of the driver. The configuration of the vehicle acoustic control device is described as above.

Next, a description is made of the acoustic control processing, which is to be executed by the controller 21, based on a block diagram.

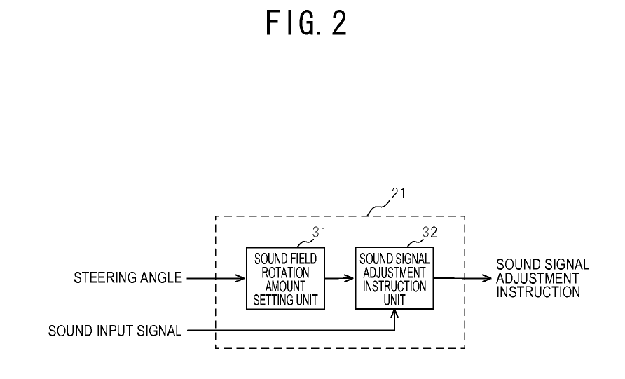

FIG. 2 is a block diagram illustrating an example of the acoustic control processing in the first embodiment.

In the acoustic control processing, a sound field rotation amount setting unit 31 and a sound signal adjustment instruction unit 32 are provided.

When an operation input for changing a turning behavior of the vehicle is made, the sound field rotation amount setting unit 31 sets a sound field rotation amount α to rotate the sound field in the vehicle cabin in a direction of the change in an actual turning behavior of the vehicle. The operation input is a change in the steering angle θs, and is supposed to be a steering input by the driver herein, without being limited thereto. That is to say, the operation input includes the steering input by an actuator in steering control such as intervention control for avoiding contact with an obstacle or for lane keeping, automated driving, or the like.

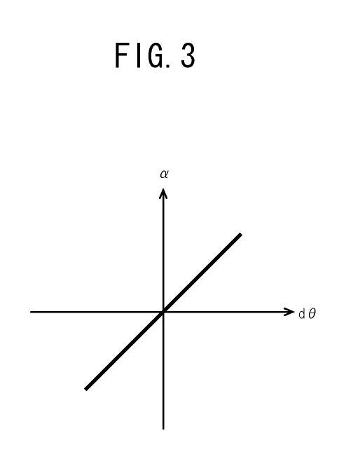

Here, a steering speed dθ is calculated on the basis of the steering angle θs, and the sound field rotation amount α is set depending on the steering speed dθ. The steering speed dθ is an amount of change of the steering angle θs per unit time, and is calculated, for example, by a time differential of the steering angle θs, or by high-pass filter processing of a steering frequency. It is to be noted that a cutoff frequency of the high-pass filter may be approximately 0.3 Hz, for example. As a matter of course, band-pass filter processing may be performed instead of the high-pass filter processing. Then the sound field rotation amount α is set depending on the steering speed dθ with reference to maps as illustrated in FIG. 3 to FIG. 5, for example.

FIG. 3 is an example of the map for use in setting the sound field rotation amount α. In accordance with this map, as the steering speed dθ is increasing from zero in a positive direction, the sound field rotation amount α increases from zero in the positive direction, and as the steering speed dθ is decreasing from zero in a negative direction, the sound field rotation amount α decreases from zero in the negative direction.

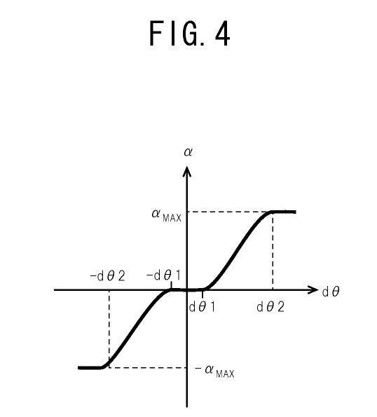

FIG. 4 an example of the map for use in setting the sound field rotation amount α (dead band, limit). Here, with regard to the steering speed dθ, dθ1 and dθ2, which establish a relationship of 0<|dθ1|<|dθ2|, are predetermined, and with regard to the sound field rotation amount α, a maximum rotation amount α_{MAX}, which establishes a relationship of 0<|α_{MAX}|, is predetermined. It is to be noted that dθ1 corresponds to a value within a range which can be regarded as vicinities of zero, and dθ2 corresponds to a value within a range which can be regarded to be relatively fast in a usual steering operation. Furthermore, the maximum rotation amount α_{MAX} is determined depending on a minimum turning diameter structurally determined for each vehicle. Then, when an absolute value of the steering speed dθ is within a range from zero to |dθ1|, the sound field rotation amount α is maintained to be zero. Furthermore, when the absolute value of the steering speed dθ is within a range from |dθ1| to |dθ2|, the sound field rotation amount α is increased within a range from zero to the maximum rotation amount α_{MAX} as the steering speed dθ is higher. Furthermore, when the absolute value of the steering speed dθ is larger than |dθ2|, the sound field rotation amount α is maintained to be the maximum rotation amount α_{MAX}.

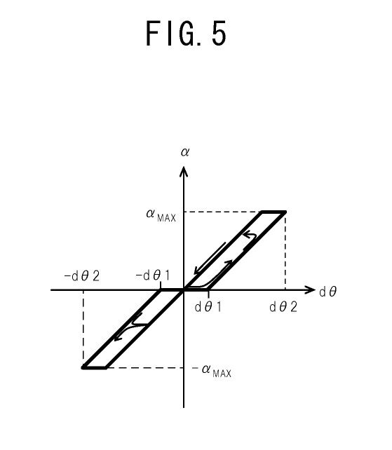

FIG. 5 is an example of the map for use in setting the sound field rotation amount α. This map can be obtained based on the map of FIG. 4 mentioned above, and by providing a hysteresis therein when the absolute value of the steering speed dθ starts to decrease after an increase. That is to say, when the absolute value of the steering speed dθ decreases from a state of increasing, the sound field rotation amount α at a time when the absolute value starts to decrease after the increase is maintained. Then, when a decrement of the absolute value of the steering speed dθ exceeds a predetermined hysteresis amount (for example, dθ1), the sound field rotation amount α decreases. Furthermore, when the absolute value of the steering speed dθ starts to decrease after the increase, and then starts to increase again before decreasing to zero, the sound field rotation amount α at a time when the absolute value starts to increase after the decrease is maintained. Then, when an increment of the absolute value of the steering speed dθ exceeds the predetermined hysteresis amount (for example, dθ1), the sound field rotation amount α is increased.

It is to be noted that though the sound field rotation amount α is set simply depending on the steering speed dθ, the setting of the sound field rotation amount α is not limited to this. For example, when the steering input is smaller than a predetermined operation amount or is shorter than a predetermined duration time, the sound field rotation amount α may be set at zero. In such a way, unnecessary control for the sound field is suppressed.

Furthermore, the steering angle θs may be substituted for the above-described steering speed dθ, and the sound field rotation amount α may be set depending on the steering angle θs.

The sound field rotation amount α is set as described above.

In order to rotate the sound field, in which the sounds are outputted by the respective speakers 23, about the coordinate origin O by α in the steering direction, the sound signal adjustment instruction unit 32 outputs a driving instruction for adjusting the sound signals to the amplifier 22.

Here, a description is made of rotation of the sound field.

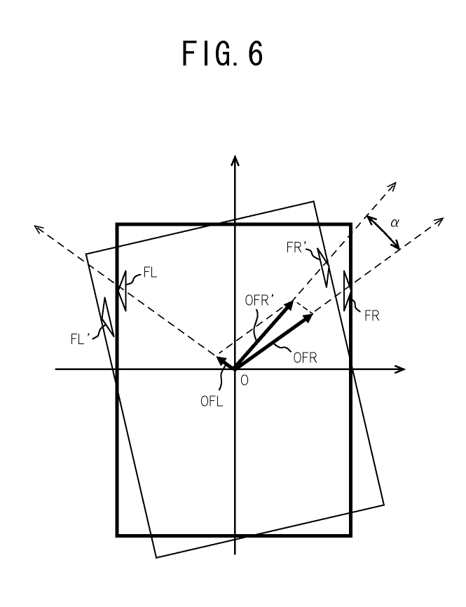

FIG. 6 is a view schematically illustrating the vehicle cabin space when viewed from above.

Here, a description is made of a case where the front left speaker is FL, the front right speaker is FR, and a sound field where the sounds are outputted from these speakers FL and FR is rotated about the coordinate origin O by the angle α in the left direction (counterclockwise). FL′ and FR′ are speaker positions at which the speakers are assumed to be rotated by the angle α. In order that the sound originally heard from the front right speaker position FR can be heard from FR′, a vector OFR′ is first resolved into a vector OFR and a vector OFL. Then, depending on a magnitude ratio of these vector OFR and vector OFL, the sound outputted from the speaker FR is distributed to the speakers FL and FR, followed by synthesis. Also with regard to the other speakers, vectors are resolved in a similar way, and thereafter, are distributed to the other speakers, followed by synthesis. In such a way, the driving instruction for adjusting the sound signal is generated and outputted.

The acoustic control processing is described as above based on the block diagram.

Next, a description is made of the acoustic control processing, which is to be executed by the controller 21, based on a flowchart.

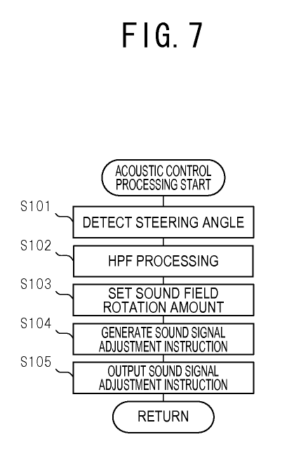

FIG. 7 is a flowchart illustrating an example of the acoustic control processing in the first embodiment.

First, in step S101, the steering angle θs is detected.

In subsequent step S102, a value corresponding to the steering speed dθ is calculated, for example, by performing the high-pass filter processing on the steering frequency. The cutoff frequency of the high-pass filter processing is, for example, approximately 0.3 Hz. In this processing, a stationary component of the steering input just needs to be removable, and the operation input for changing the turning behavior of the vehicle just needs to be extractable.

In subsequent step S103, the sound field rotation amount α is set depending on the steering speed dθ.

The acoustic control processing is described as above based on the flowchart.

### (Functions)

Next, a description is made of functions of the first embodiment.

In the present embodiment, the plurality of speakers 23 are disposed so as to surround a periphery of a passenger when viewed from above, and a multiple-channel sound is reproduced stereophonically by the plurality of speakers 23. Then, when the steering input for changing the turning behavior of the vehicle is made, the sound field in the vehicle cabin is rotated in the direction (steering direction) of the change in the actual turning behavior of the vehicle, as feedforward control. Specifically, a volume distribution of the respective channels is changed, whereby the sound field is rotated.

In general, when a tree grows slantingly, a person tends to be given the illusion that the road is inclined, and it is known that a person recognizes an attitude change of his/her own also by a sound. Accordingly, when the sound field in the vehicle cabin is rotated in the direction of the change in the actual turning behavior of the vehicle, the change in the turning behavior depending on the steering input can be rendered. Therefore, since the driver imagines the change in the turning behavior on the basis of his/her steering input and the imagined turning behavior matches the motion of the sound field, the operation feeling is improved.

Furthermore, there is some amount of response difference from when the steering input is made till when the steering input is reflected in an actual vehicle behavior. By rendering the change in the turning behavior depending on the steering input before the change of the actual turning behavior of the vehicle, a feeling (impression) that the responsiveness of the vehicle behavior to the steering input is improved can be given to the passenger (especially to the driver). It is to be noted that as silence of the vehicle cabin space is higher, such an acoustic effect as described above is considered to be high, and accordingly, the first embodiment is suitable for a time when a hybrid vehicle runs by a motor (EV mode), an electric vehicle and the like.

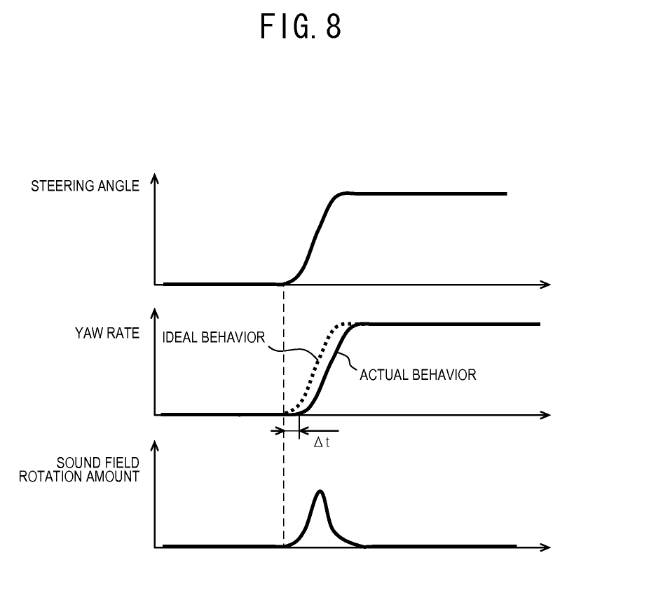

FIG. 8 is a time chart explaining the response difference in the actual vehicle behavior.

Here, a description is made of a case where the steering operation is started to turn the vehicle in a state where the vehicle travels almost straightly.

When a yaw rate is generated at the almost same time when the steering operation starts to increase the steering angle θs from zero, an ideal behavior in which the response difference Δt is about zero is achieved. However, the actual vehicle behavior has some amount of response difference Δt relative to the increase of the steering angle θs. Thus, by increasing the sound field rotation amount α from when the steering angle θs starts to increase from zero to render the change in the turning behavior depending on the steering input, a feeling that the responsiveness of the vehicle behavior is improved can be given to the passenger.

The sound field rotation amount α is set depending on the steering speed dθ, and the sound field rotation amount α is set larger as the steering speed dθ is faster. This is because the response difference from when the steering input is made till when the steering input is reflected in the actual vehicle behavior is larger (more conspicuous), as the steering speed dθ is faster, and the response difference from when the steering input is made till when the steering input is reflected in the actual vehicle behavior is smaller (more inconspicuous) as the steering speed dθ is slower. Therefore, by setting the sound field rotation amount α larger as the steering speed dθ is faster, the change in the turning behavior depending on the steering input can be effectively rendered.

Furthermore, when a certain steering angle θs is kept (steering-hold) by the steering operation, the steering speed dθ is about zero, and thus the sound field rotation amount α is also about zero. Therefore, after the steering input is made, by the time when the actual turning behavior of the vehicle starts to change, the sound field returns to a state before the sound field in the vehicle cabin is rotated, that is, an usual initial state. That is to say, by the time when the actual turning behavior catches up to the steering input, the rendering of the turning behavior by the rotation of the sound field is terminated. This is because when the state in which the sound field in the vehicle cabin keeps rotating continues although the actual turning behavior catches up to the steering input, such an unnatural rendering may give an uncomfortable feeling to the driver.

Furthermore, when the steering input is smaller than a predetermined operation amount or is shorter than a predetermined duration time, the sound field rotation amount α may be set at zero. In such a way, a situation where the control for the sound field is performed unnecessarily to give an uncomfortable feeling to the driver can be suppressed.

Furthermore, since the sound field rotation amount α is limited by the maximum rotation amount α_{MAX} as an upper limit, the sound field rotation amount α can be suppressed from being too large unnecessarily. Furthermore, since the maximum rotation amount α_{MAX} is determined depending on the minimum turning diameter specific to each vehicle, the turning behavior suitable to the vehicle can be rendered.

Next, a description is made of recognition timing of the behavior change.

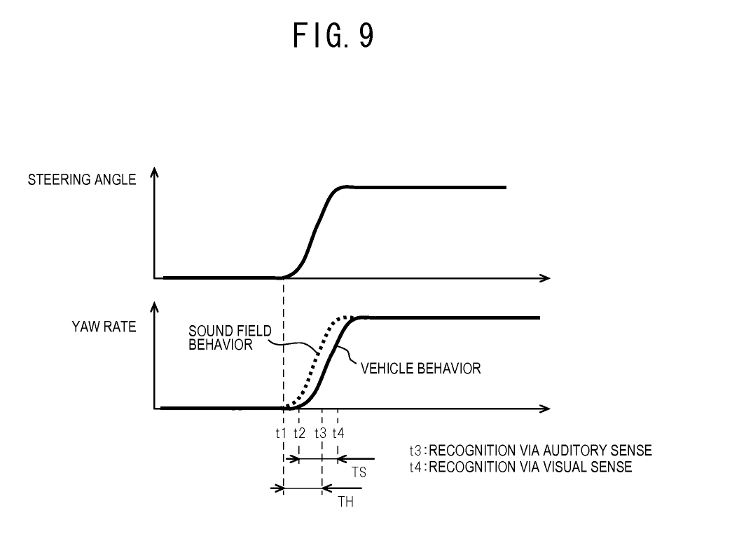

FIG. 9 is a time chart explaining the recognition timing of the behavior change.

Also here, a description is made of a case where the steering operation is started to turn the vehicle in a state where the vehicle travels almost straightly.

At time t1, the steering operation starts to increase the steering angle θs from zero. There is some amount of response difference from when the steering input is made till when this steering input is reflected in the actual vehicle behavior. That is to say, at time t2 after time t1, the vehicle starts to turn in response to the steering operation and the yaw rate is generated. In the present embodiment, by rotating the sound field in the vehicle cabin in the direction of the change in the actual turning behavior at time t1 when the steering input is made, the change in the turning behavior depending on the steering input can be rendered.

Here, a comparison is made between a timing of recognizing the change in the sound field behavior via an auditory sense and a timing of recognizing the change in the vehicle behavior via a visual sense.

Time t3 after the lapse of a simple reaction time TH of the auditory sense from time t1 when the sound field behavior starts to change is the timing of recognizing the change in the sound field behavior via the auditory sense. Furthermore, time 4 after the lapse of a simple reaction time TS of the visual sense from time t2 when the vehicle behavior starts to change is the timing of recognizing the change in the vehicle behavior via the visual sense. In general, the simple reaction time TH of the auditory sense is about 140 to 160 msec, and the simple reaction time TS of the visual sense is about 180 to 200 msec. Therefore, since the change timing of the sound field behavior is earlier than the change timing of the vehicle behavior and the simple reaction time of the auditory sense is shorter than the simple reaction time of the visual sense, a feeling that the responsiveness of the vehicle behavior to the steering input is improved can be effectively given to the passenger.

### (Applications)

In the present embodiment, the sound field in the vehicle cabin is controlled by adjusting a primary sound based on the sound signal from the acoustic equipment 11, however, the control of the sound field is not limited thereto. For example, it may be assumed that there are virtual walls surrounding a periphery of the vehicle when viewed from above, whereby a reverberating sound of the primary sound from the virtual walls may be assumed and generated, and the reverberating sound may be outputted by the respective speakers 23 as a secondary sound. Then, when the steering input is made, the virtual walls may be rotated in the direction of the change in the actual turning behavior.

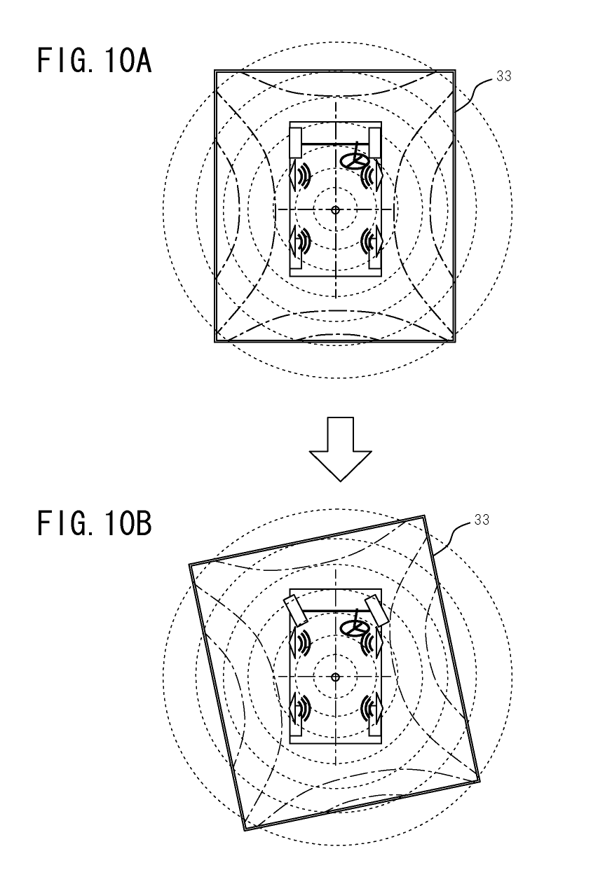

FIGS. 10A and 10B are views explaining the virtual walls.

Here, a ripple (dotted lines) expanding radially from a center of the vehicle cabin space indicates the primary sound based on the sound signal from the acoustic equipment 11. Furthermore, the square (double solid line) surrounding the periphery of the vehicle when viewed from above indicates virtual walls 33. Furthermore, the ripples (dashed-dotted line) moving from respective sides of the virtual walls 33 toward the center of the vehicle cabin space indicate reverberating sounds of the primary sound from the virtual walls 33.

FIG. 10A illustrates a state in which the vehicle travels almost straightly and the steering input for turning the vehicle is not made, and FIG. 10B illustrate a state after the steering input for turning the vehicle is made from the state illustrated in FIG. 10A.

As well as the primary sound is outputted by the respective speakers 23, the reverberating sounds of the primary sound from the virtual walls 33 is generated by assuming that there are the virtual walls 33 surrounding the periphery of the vehicle. By outputting the reverberating sounds by the respective speakers 23 as the secondary sounds, an acoustic effect like listening in a hall, a church, or the like can be reproduced in a simulative manner. Therefore, not only by simply rotating the sound field by the primary sound but also by rotating the virtual walls 33 to rotate the secondary sounds, the rotation of the sound field can be rendered in a more realistic manner to obtain an acoustic effect giving the sense of reality.

As described above, the speakers 23LFL to 23LRR and 23UFL to 23URR correspond to the “plurality of speakers”, and the acoustic control processing to be executed by the controller 21 corresponds to the “sound field control unit”.

(Effects)

Next, a description is made of effects of main portions in the first embodiment.

The vehicle acoustic control device of the present embodiment includes: the plurality of speakers 23 disposed on the periphery of the passenger; and the controller 21 that controls the sound field in the vehicle cabin by individually driving the plurality of speakers 23. The controller 21 is configured to, when the operation input for changing the vehicle behavior is made, change the sound field in the vehicle cabin in the direction of the change in the actual vehicle behavior depending on the operation input.

As described above, since the change in the vehicle behavior depending on the operation input is rendered by changing the sound field in the vehicle cabin in the direction of the change in the actual vehicle behavior, the matching between the imagined vehicle behavior and the motion of the sound field in the vehicle cabin can be improved.

(2) In the vehicle acoustic control device of the present embodiment, the plurality of speakers 23 are disposed so as to surround a periphery of a passenger when viewed from above, and the controller 21 is configured to, when the operation input for changing the turning behavior of the vehicle is made, rotate the sound field in the vehicle cabin in the direction of the change in the actual turning behavior of the vehicle.

As described above, since the change in the turning behavior depending on the operation input is rendered by changing the sound field in the vehicle cabin in the direction of the change in the turning behavior of the vehicle, the matching between the imagined vehicle behavior and the motion of the sound field in the vehicle cabin can be improved.

(3) In the vehicle acoustic control device of the present embodiment, the controller 21 is configured to set the sound field rotation amount α larger as the steering speed dθ for changing the turning behavior of the vehicle is faster.

As described above, by setting the sound field rotation amount α larger as the steering speed dθ is faster, the change in the turning behavior depending on the steering input can be effectively rendered.

(4) In the vehicle acoustic control device of the present embodiment, the maximum rotation amount α_{MAX} in rotating the sound field is determined depending on the minimum turning diameter determined for each vehicle.

As described above, by determining the maximum rotation amount α_{MAX} of the sound filed depending on the minimum turning diameter determined for each vehicle, the turning behavior suitable to the vehicle can be rendered.

(5) In the vehicle acoustic control device of the present embodiment, the controller 21 is configured to drive the plurality of speakers 23 by the sound signals that enable the stereophonic reproduction of reproducing a multiple-channel sound, and to change the volume distribution of the respective channels so as to rotate the sound field.

As described above, by changing the volume distribution of the respective channels to rotate the sound field, the control for the sound field can be performed easily.

(6) In the vehicle acoustic control device of the present embodiment, the controller 21 is configured to output the primary sound by the plurality of speakers 23, to assume and generate the reverberating sound of the primary sound from the virtual wall 33 by assuming that there are the virtual wall 33 surrounding the periphery of the vehicle when viewed from above, and to output the reverberating sound by the plurality of speakers 23, as the secondary sound. Then, the controller 21 is configured to, when the operation input for changing the turning behavior of the vehicle is made, rotate the virtual wall 33 in the direction of the change in the actual turning behavior of the vehicle depending on the operation input.

As described above, by rotating the virtual wall 33 in the direction of the change in the turning behavior, the rotation of the sound field can be rendered in a more realistic manner to obtain an acoustic effect giving the sense of reality.

(7) In the vehicle acoustic control method of the present embodiment, the plurality of speakers 23 disposed on the periphery of the passenger are individually driven, whereby the sound field in the vehicle cabin is controlled. Then, when the operation input for changing the vehicle behavior is made, the sound field in the vehicle cabin is changed depending on the operation input before the change in the actual vehicle behavior so as to render the change in the vehicle behavior depending on the operation input.

As described above, since the sound field in the vehicle cabin is changed depending on the operation input before the change in the actual vehicle behavior so as to render the change in the vehicle behavior depending on the operation input, the matching between the imagined vehicle behavior and the motion of the sound field in the vehicle cabin can be improved.

### Second Embodiment

### (Configuration)

In the present embodiment, when the operation input for changing the turning behavior of the vehicle is made, the sound field of the vehicle cabin is rotated in the direction of the change in the actual turning behavior depending on a deviation between a normative turning behavior and the actual turning behavior. That is to say, the change of the turning behavior depending on the operation input is rendered before the change in the actual turning behavior.

The configuration of the device is the same to that of the first embodiment mentioned above.

Next, a description is made of the acoustic control processing, which is to be executed by the controller 21, based on a block diagram.

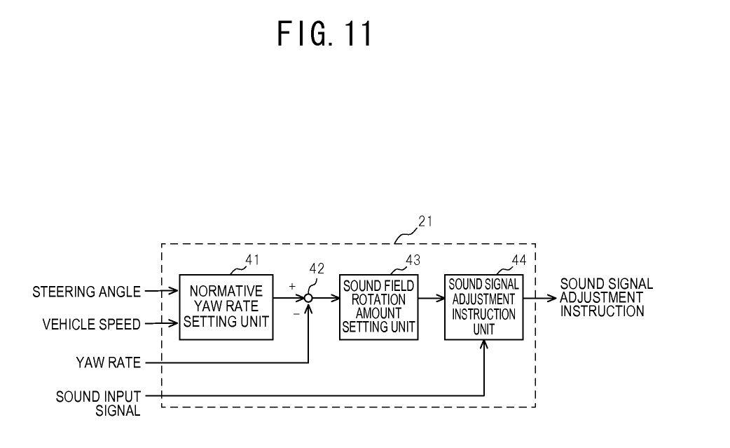

FIG. 11 is a block diagram illustrating an example of the acoustic control processing in the second embodiment.

In the acoustic control processing, a normative yaw rate setting unit 41, a deviation computing unit 42, a sound field rotation amount setting unit 43, and a sound signal adjustment instruction unit 44 are provided.

The normative yaw rate setting unit 41 sets a normative yaw rate γN depending on the steering angle θs and a vehicle speed V.

The deviation computing unit 42 computes a deviation Δγ of an actual yaw rate ωz (hereinafter, referred to as “γR”) relative to the normative yaw rate γN by subtracting the actual yaw rate γR from the normative yaw rate γN. It is to be noted that the deviation Δγ indicates a shortage (response difference) of the actual yaw rate γR relative to the normative yaw rate γN. Therefore, when the normative yaw rate γN and the actual yaw rate γR have the same sign and the absolute value of the actual yaw rate γR is larger than the absolute value of the normative yaw rate γN, the deviation Δγ is computed to be zero. Thus, even when the deviation Δγ has a negative value, this means that the turning direction is a negative direction and does not means that the actual yaw rate γR catches up and overtakes the normative yaw rate γN.

When the operation input for changing the turning behavior of the vehicle is made, the sound field rotation amount setting unit 43 sets the sound field rotation amount α to rotate the sound field in the vehicle cabin in the direction of the change in the actual turning behavior of the vehicle depending on the deviation Δγ. The operation input is the change in the steering angle θs, and is supposed to be the steering input by the driver herein without being limited thereto. That is to say, the operation input includes the steering input by the actuator in the steering control such as the intervention control for avoiding contact with an obstacle or for lane keeping, automated driving, or the like.

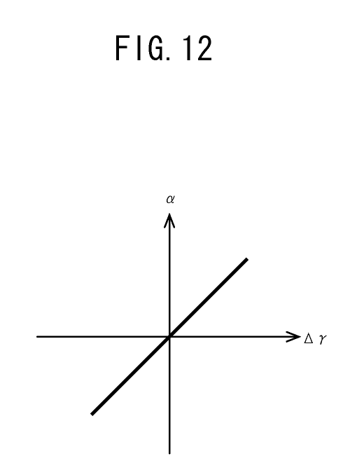

FIG. 12 is an example of the map for use in setting the sound field rotation amount α.

In accordance with this map, as the deviation Δγ is increasing from zero in a positive direction, the sound field rotation amount α increases from zero in the positive direction, and as the deviation Δγ is decreasing from zero in a negative direction, the sound field rotation amount α decreases from zero in the negative direction.

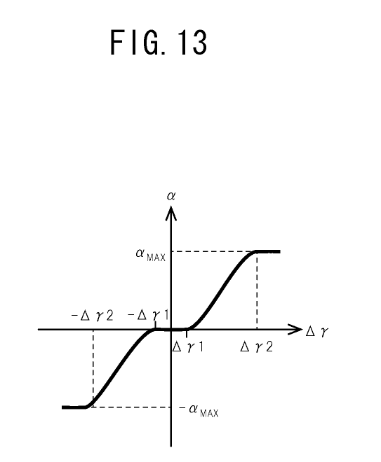

FIG. 13 is an example of the map for use in setting the sound field rotation amount α (dead band, limit).

Here, with regard to the deviation Δγ, Δγ1 and Δγ2, which establish a relationship of 0<|Δγ1|<|Δγ2|, are predetermined, and with regard to the sound field rotation amount α, a maximum rotation amount α_{MAX}, which establishes a relationship of 0<|α_{MAX}|, is predetermined. It is to be noted that Δγ1 corresponds to a value within a range which can be regarded as vicinities of zero, and Δγ 2 corresponds to a value within a range which can be regarded to be relatively fast in a usual steering operation. Furthermore, the maximum rotation amount α_{MAX} is determined depending on a minimum turning diameter structurally determined for each vehicle. Then, when an absolute value of the deviation Δγ is within a range from zero to |Δγ1|, the sound field rotation amount α is maintained to be zero. Furthermore, when the absolute value of the deviation Δγ is within a range from |Δγ1| to |Δγ2|, the sound field rotation amount α is increased within a range from zero to the maximum rotation amount α_{MAX} as the deviation Δγ is faster. Furthermore, when the absolute value of the deviation Δγ is larger than |Δγ2|, the sound field rotation amount α is maintained to be the maximum rotation amount α_{MAX}.

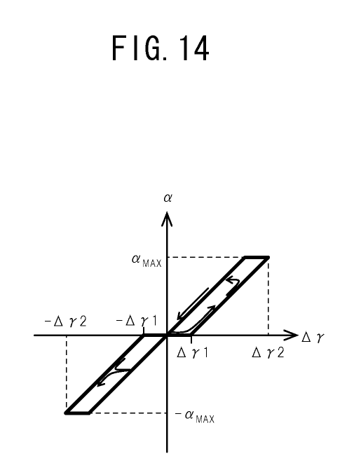

FIG. 14 is an example of the map for use in setting the sound field rotation amount α (hysteresis).

This map can be obtained based on the map of FIG. 13 mentioned above, and by providing a hysteresis therein when the absolute value of the deviation Δγ starts to decrease after an increase. That is to say, when the absolute value of the deviation Δγ decreases from a state of increasing, the sound field rotation amount α at a time when the absolute value starts to decrease after the increase is maintained. Then, when a decrement of the absolute value of the deviation Δγ exceeds a predetermined hysteresis amount (for example, Δγ1), the sound field rotation amount α decreases. Furthermore, when the absolute value of the deviation Δγ starts to decrease after the increase, and then starts to increase again before decreasing to zero, the sound field rotation amount α at a time when the absolute value starts to increase after the decrease is maintained. Then, when an increment of the absolute value of the deviation Δγ exceeds the predetermined hysteresis amount (for example, Δγ1), the sound field rotation amount α is increased.

It is to be noted that though the sound field rotation amount α is set simply depending on the deviation Δγ, the setting of the sound field rotation amount α is not limited to this. For example, when the steering input is smaller than the predetermined operation amount or is shorter than the predetermined duration time, the sound field rotation amount α may be set at zero. In such a way, unnecessary control for the sound field is suppressed.

Furthermore, a deviation Δφ of an actual yaw angle θR relative to a normative yaw angle θN may be computed by integrating the deviation Δγ and the sound field rotation amount α may be set depending on the deviation Δφ instead of the deviation Δγ mentioned above.

Furthermore, the deviation Δγ may be corrected by multiplying the deviation Δγ by a gain depending on the vehicle speed V and a transverse acceleration Gy.

The sound field rotation amount α is set as described above.

In order to rotate the sound field, in which the sounds are outputted by the respective speakers 23, about the coordinate origin O by α in the steering direction, the sound signal adjustment instruction unit 44 outputs a driving instruction for adjusting the sound signal to the amplifier 22.

The acoustic control processing is described as above based on the block diagram.

Next, a description is made of the acoustic control processing, which is to be executed by the controller 21, based on a flowchart.

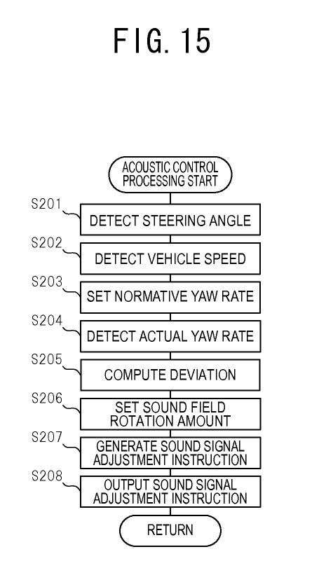

FIG. 15 is a flowchart illustrating an example of the acoustic control processing in the second embodiment.

First, in step S201, the steering angle θs is detected.

In subsequent step S202, the vehicle speed V is detected.

In subsequent step S203, the normative yaw rate γN is set depending on the steering angle θs and the vehicle speed V by using the bicycle model.

In subsequent step S204, the actual yaw rate γR is detected.

In subsequent step S205, the deviation Δγ (=γN−γR) of the actual yaw rate γR relative to the normative yaw rate γN.

In subsequent step S206, the sound field rotation amount α is set depending on the deviation Δγ.

In subsequent step S207, in order to rotate the sound field, in which the sounds are outputted by the respective speakers 23, about the coordinate origin O by α in the steering direction, the driving instruction for adjusting the sound signal is generated.

In subsequent step S208, the driving instruction for adjusting the sound signal is outputted to the amplifier 22, and the acoustic control processing returns to a predetermined main program.

The acoustic control processing is described as above based on the flowchart.

(Functions)

Next, a description is made of functions of the second embodiment.

In the present embodiment, the plurality of speakers 23 are disposed so as to surround the periphery of the passenger when viewed from above, and a multiple-channel sound is reproduced stereophonically by the plurality of speakers 23. Then, when the steering input for changing the turning behavior of the vehicle is made, the deviation Δγ of the actual yaw rate γR relative to the normative yaw rate γN is computed and the sound field in the vehicle cabin is rotated depending on the deviation Δγ in the direction (steering direction) of the change in the actual turning behavior of the vehicle, as feedforward control. Specifically, a volume distribution of the respective channels is changed, whereby the sound field is rotated.

In general, when a tree grows slantingly, a person tends to be given the illusion that the road is inclined, and it is known that a person recognizes an attitude change of his/her own also by a sound. Accordingly, when the sound field in the vehicle cabin is rotated depending on the deviation Δγ in the direction of the change in the actual turning behavior of the vehicle, the change in the turning behavior depending on the steering input can be rendered. Therefore, since the driver imagines the change in the turning behavior on the basis of his/her steering input and the imagined turning behavior matches the motion of the sound field, the operation feeling is improved.

In this situation, there is some amount of response difference from when the steering input is made till when the steering input is reflected in the actual vehicle behavior. By rendering the change in the turning behavior depending on the steering input before the change of the actual turning behavior of the vehicle, a feeling (impression) that the responsiveness of the vehicle behavior to the steering input is improved can be given to the passenger (especially to the driver). It is to be noted that as silence of the vehicle cabin space is higher, such an acoustic effect as described above is considered to be high, and accordingly, the second embodiment is suitable for a time when a hybrid vehicle runs by a motor (EV mode), an electric vehicle and the like.

Here, a description is made of a case where the steering operation is started to turn the vehicle in a state where the vehicle travels almost straightly.

When a yaw rate is generated at the almost same time when the steering operation starts to increase the steering angle θs from zero, an ideal behavior (almost the normative yaw rate γN) in which the response difference Δt is about zero is achieved. However, the actual vehicle behavior has some amount of response difference Δt relative to the increase of the steering angle θs. Thus, when the steering angle θs starts to increase from zero whereby the response difference of the actual yaw rate γR relative to the normative yaw rate γN is generated, by increasing the sound field rotation amount α to render the change in the turning behavior depending on the steering input, a feeling that the responsiveness of the vehicle behavior is improved can be given to the passenger.

The sound field rotation amount α is set depending on the deviation Δγ, and the sound field rotation amount α is set larger as the deviation Δγ is larger. As described above, by setting the sound field rotation amount α larger as the deviation Δγ is larger, the change in the turning behavior depending on the steering input can be effectively rendered. Furthermore, as the deviation Δγ becomes smaller while the actual yaw rate γR gradually catches up the normative yaw rate γN, the sound field rotation amount α becomes smaller. Then, when the deviation Δγ is eliminated, the sound field rotation amount α becomes zero. As described above, by the time when the actual turning behavior of the vehicle starts to change and the response difference is eliminated, the sound field returns to a state before the sound field in the vehicle cabin is rotated, that is, the usual initial state. That is to say, by the time when the actual turning behavior catches up to the steering input, the rendering of the turning behavior by the rotation of the sound field is terminated. This is because when the state in which the sound field in the vehicle cabin keeps rotating continues although the actual turning behavior catches up to the steering input, such an unnatural rendering may give an uncomfortable feeling to the driver.

Furthermore, when the steering input is smaller than a predetermined operation amount or is shorter than a predetermined duration time, the sound field rotation amount α may be set at zero. In such a way, a situation where the control for the sound field is performed unnecessarily to give an uncomfortable feeling to the driver can be suppressed.

Furthermore, since the sound field rotation amount α is limited by the maximum rotation amount α_{MAX} as an upper limit, the sound field rotation amount α can be suppressed from being too large unnecessarily. Furthermore, since the maximum rotation amount α_{MAX} is determined depending on the minimum turning diameter specific to each vehicle, the turning behavior suitable to the vehicle can be rendered.

In the present embodiment, the other portions common to the first embodiment mentioned above have similar functions and effects, and thus detailed descriptions thereof are omitted.

(Applications)

In the present embodiment, the sound field in the vehicle cabin is changed in the direction of the change in the actual vehicle behavior depending on the deviation Δγ of the actual yaw rate γR relative to the normative yaw rate γN, however, the control of the sound field is not limited thereto. For example, the present embodiment may be adopted to be combined with the first embodiment. That is to say, when the operation input for changing the vehicle behavior is made, the rotation amount α of the sound field may be set larger as the steering speed dθ is higher and the deviation Δγ is larger. For example, an average value of the rotation amount α which is set depending on the steering speed dθ and the rotation amount α which is set depending on the deviation Δγ, a sum of these rotation amounts after being weighted, for example, may be set as a final rotation amount α.

As described above, the speakers 23LFL to 23LRR and 23UFL to 23URR correspond to the “plurality of speakers”, and the acoustic control processing to be executed by the controller 21 corresponds to the “sound field control unit”. Furthermore, the normative yaw rate setting unit 41 corresponds to the “turning behavior estimation unit” and the 6-axis motion sensor 14 corresponds to the “actual turning behavior detection unit”.

### (Effects)

Next, a description is made of effects of main portions in the second embodiment.

The vehicle acoustic control device of the present embodiment includes: the plurality of speakers 23 disposed so as to surround the periphery of the passenger when viewed from above; and the controller 21 that controls the sound field in the vehicle cabin by individually driving the plurality of speakers 23. The controller 21 is configured, when the operation input for changing the vehicle behavior is made, to set the normative yaw rate γN, to detect the actual yaw rate γR, and to change the sound field in the vehicle cabin in the direction of the change in the actual vehicle behavior depending on the deviation Δγ of the actual yaw rate γR relative to the normative yaw rate γN.

As described above, by changing the sound field in the vehicle cabin in the direction of the change in the actual vehicle behavior depending on the deviation Δγ of the actual yaw rate γR relative to the normative yaw rate γN, the change of the turning behavior depending on the operation input can be rendered before the change in the actual turning behavior. Therefore, the matching between the imagined vehicle behavior and the motion of the sound field in the vehicle cabin can be improved.

(2) In the vehicle acoustic control device of the present embodiment, the controller 21 is configured to set the sound field rotation amount α larger as the deviation Δγ for changing the turning behavior of the vehicle is larger.

As described above, by setting the sound field rotation amount α larger as the deviation Δγ is larger, the change in the turning behavior depending on the steering input can be effectively rendered.

(3) In the vehicle acoustic control device of the present embodiment, the maximum rotation amount α_{MAX} in rotating the sound field is determined depending on the minimum turning diameter determined for each vehicle.

As described above, by determining the maximum rotation amount α_{MAX} of the sound field depending on the minimum turning diameter determined for each vehicle, the turning behavior suitable to the vehicle can be rendered.

(4) In the vehicle acoustic control device of the present embodiment, the controller 21 is configured to drive the plurality of speakers 23 by the sound signals that enable the stereophonic reproduction of reproducing a multiple-channel sound, and to change the volume distribution of the respective channels so as to rotate the sound field.

As described above, by changing the volume distribution of the respective channels to rotate the sound field, the control for the sound field can be performed easily.

(5) In the vehicle acoustic control device of the present embodiment, the controller 21 is configured to output the primary sound by the plurality of speakers 23, to assume and generate the reverberating sound of the primary sound from the virtual wall 33 by assuming that there are the virtual wall 33 surrounding the periphery of the vehicle, and to output the reverberating sound by the plurality of speakers 23, as the secondary sound. Then, the controller 21 is configured to, when the operation input for changing the turning behavior of the vehicle is made, rotate the virtual wall 33 in the direction of the change in the actual turning behavior of the vehicle depending on the deviation Δγ.

As described above, by rotating the virtual wall 33 in the direction of the change in the turning behavior, the rotation of the sound field can be rendered in a more realistic manner to obtain an acoustic effect giving the sense of reality.

(6) In the vehicle acoustic control method of the present embodiment, the plurality of speakers 23 disposed so as to surround the periphery of the passenger when viewed from above are individually driven, whereby the sound field in the vehicle cabin is controlled. Then, when the operation input for changing the vehicle behavior is made, the normative yaw rate γN is set depending on the operation input, the actual yaw rate γR of the vehicle is detected, and the sound field in the vehicle cabin is changed depending on the deviation Δγ of the actual yaw rate γR relative to the normative yaw rate γN before the change in the actual vehicle behavior to render the change in the vehicle behavior depending on the operation input.

As described above, since the sound field in the vehicle cabin is changed depending on the deviation Δγ of the actual yaw rate γR relative to the normative yaw rate γN before the change in the actual vehicle behavior to render the change in the vehicle behavior depending on the operation input, the matching between the imagined vehicle behavior and the motion of the sound field in the vehicle cabin can be improved.

Here, the present invention has been described with reference to the definite number of embodiments; however, the scope of the present invention is not limited thereto and improvements and modifications of the embodiments based on the above disclosure are obvious to those skilled in the art.

1. A vehicle acoustic control device comprising:
a plurality of speakers each disposed on a periphery of a passenger;
a sound field control unit configured to control a sound field in a vehicle cabin by individually driving the plurality of speakers;
a steering operation detection unit configured to detect a steering operation;
a turning behavior estimation unit configured to estimate a turning behavior based on the steering operation; and
an actual turning behavior detection unit configured to detect an actual turning behavior of a vehicle which is turning,
wherein the sound field control unit is configured to, when the steering operation detection unit detects the steering operation, change the sound field in the vehicle cabin in a direction of a change in the actual turning behavior depending on a deviation between an estimated turning behavior which is estimated by the turning behavior estimation unit and the actual turning behavior detected by the actual turning behavior detection unit.

2. The vehicle acoustic control device according to claim 1, wherein the sound field control unit is configured to set an amount of a change of the sound field larger as the deviation is larger.

3. A vehicle acoustic control device comprising:
a plurality of speakers each disposed on a periphery of a passenger;
a sound field control unit configured to control a sound field in a vehicle cabin by individually driving the plurality of speakers; and
a steering operation detection unit configured to detect a steering operation,
wherein the sound field control unit is configured to, when the steering operation detection unit detects the steering operation, change the sound field in the vehicle cabin in a direction of a change in the actual turning behavior depending on the steering operation before the change in the actual turning behavior of the vehicle, and terminate a change in the sound field by time when the actual turning behavior catches up to the steering operation.

4. The vehicle acoustic control device according to claim 3, wherein the sound field control unit is configured to set an amount of a change of the sound field larger as the steering operation is faster.

5. The vehicle acoustic control device according to claim 1, wherein a maximum amount of a change in changing the sound field by the sound field control unit is determined depending on a minimum turning diameter determined for each vehicle.

6. The vehicle acoustic control device according to claim 1, wherein the sound field control unit is configured to drive the plurality of speakers by sound signals that enable a stereophonic reproduction of reproducing a multiple-channel sound, and to change a volume distribution of respective channels so as to change the sound field.

7. The vehicle acoustic control device according to claim 1, wherein the sound field control unit is configured to:
output a primary sound from each of the plurality of speakers;
assume that there is a virtual wall surrounding the vehicle when viewed from above;
assume and generate a reverberating sound of the primary sound from the virtual wall;
output the reverberating sound from each of the plurality of speakers, as a secondary sound; and
change the virtual wall in the direction of the change in the actual turning behavior.

8. A vehicle acoustic control method of controlling a sound field in a vehicle cabin by individually driving a plurality of speakers each disposed on a periphery of a passenger, the vehicle acoustic control method comprising:
detecting a steering operation;
estimating a turning behavior based on the steering operation;
detecting an actual turning behavior of a vehicle which is turning; and
changing, when the steering operation is detected, the sound field in the vehicle cabin in a direction of a change in the actual turning behavior depending on an deviation between the estimated turning behavior and the actual turning behavior.
